(19) United States
(12) Patent Application Publication
(10) Pub. No.: US 2013/0302706 A1
(43) Pub. Date: Nov. 14, 2013

(54) DEVICE FOR GENERATING ELECTRICITY USING A FUEL CELL

(71) Applicant: David Olsommer, Attalens (CH)

(72) Inventor: David Olsommer, Attalens (CH)

(73) Assignees: MICHELIN RECHERCHE ET TECHNIQUE S.A., Granges-Paccot (CH); COMPAGNIE GENERALE DES ETABLISSEMENTS MICHELIN, Clermont-Ferrand (FR)

(21) Appl. No.: 13/989,005

(22) PCT Filed: Dec. 5, 2011
(86) PCT No.: PCT/EP11/71700

§ 371 Date: Jul. 17, 2013

(30) Foreign Application Priority Data
Dec. 6, 2010 (FR) 1060097

(51) Int. Cl. H01M 8/04

(52) U.S. Cl. CPC H01M 8/04126
USPC 429/413

(57) ABSTRACT

The invention relates to a device for generating electricity using a fuel cell, comprising means for producing fuel gas and oxidant gas, and at least one conditioning unit for one of the fuel and oxidant gases. The conditioning unit comprises at least one means for dehydrating the gas before its storage under pressure, at least one means for storing the gas under pressure, and at least one means for humidifying the gas after it has been taken out of storage. According to the invention, the dehydration means is configured in such a way that, in fuel cell operating mode, it operates at a temperature of at least 60° C. and at least partially humidifies the gas passing through it in fuel cell operating mode, by restoring at least some of the water extracted from the gas that passed through it in the gas production and storage mode.

The invention relates to a device for generating electricity using a fuel cell.

The invention relates more specifically to a “closed-loop” or “integrated system” device for generating electricity using a fuel cell, in other words a device in which the means for producing the gases supplied to the fuel cell, the means for conditioning and storing these gases, and the fuel cell itself are combined in a single device. Integrated systems of this type are described in US2004126641 and WO03041204.

The invention is described more particularly, but not exclusively, in relation to applications in the motor industry, where this technology is being extensively researched and appears to be promising. The invention may also be used advantageously in the marine or aeronautical fields.

These applications may be mobile, where the device for generating electricity using a fuel cell is on board a vehicle, or stationary, where the device for generating electricity using a fuel cell is a means located outside the vehicle and is intended to supply energy to a vehicle at a station. The application may also be used in the stationary field for energy storage.

In the case of a mobile application, the device for generating electricity using a fuel cell is generally combined with another energy source which may be electrical in nature, such sources including, but not being limited to, photovoltaic panels. A device of this type for generating electricity using a fuel cell can thus be used to generate and store energy, and to supply electrical energy on demand where the main energy source is not available or is inadequate.

It is known that fuel cells can be used to generate electrical energy directly by an electrochemical oxidation-reduction reaction using a fuel gas such as gaseous hydrogen and an oxidant gas such as gaseous oxygen or air, without passing through any intermediate mechanical energy conversion.

Fuel cells are called “hydrogen-oxygen fuel cells” when the fuel and oxidant gases are gaseous hydrogen and gaseous oxygen respectively, or as “hydrogen-air fuel cells” when the fuel and oxidant gases are gaseous hydrogen and air respectively.

A fuel cell generally includes a serial combination of unitary elements, each unitary element being essentially composed of an anode and a cathode separated by an electrolyte. A conventional electrolyte used in applications in the motor industry is a solid electrolyte, essentially composed of a polymer membrane, which allows ions to pass from the anode to the cathode. An example of a specific membrane of this type is that marketed by DuPont under the trade name “Nafion”.

These membranes must have high ionic conductivity, because the hydrogen protons pass through them, and they must be electrically insulating, to ensure that the electrons travel through the electrical circuit which is external to the cell. It is known that, not only for membranes of the aforementioned type, but also for other membranes used as a solid electrolyte in fuel cells, the conductivity of the membranes is a function of their water content. Consequently, the gases supplied to the cell must have a sufficient moisture content. Thus a fuel cell must be supplied with fuel gas and oxidant gas with a water content which is sufficient but not excessive.

For this purpose, the fuel and oxidant gases supplied to the fuel cell may be produced by a multi-step process, described below for the case of a hydrogen-oxygen fuel cell.

The first step, in the case of a hydrogen-oxygen fuel cell, is that of producing gaseous hydrogen and gaseous oxygen, using a means for producing gas by electrolysis, known as an electrolyser, the water being recoverable at the outlet of the fuel cell, as described in WO 2010/024594. In this case, the gaseous hydrogen and gaseous oxygen flowing out of the electrolyser are saturated with water vapour. At the end of this first step, the hydrogen and oxygen gases are conditioned separately, and the steps described below are described for a given gas.

The second step consists in the dehydration of each gas before its pressurized storage, in other words the drying of the gas or at least the partial extraction of the water contained therein. The dehydration of the gas is necessary because water condensation reduces the service life of any compressors which may be used to compress the gas before storage, as well as the life of the gas storage tanks. The gas is normally dried either by cooling and condensing the gas, or by passing it through a dehydration means. Drying by cooling and condensing the gas requires an energy input. Drying by passing the gas through a dehydration means is normally carried out using a dehydration means comprising a desiccant material in the solid phase. In particular, the dehydration means may be a dehydration column, generally packed with desiccant granules such as silica gel granules, as mentioned in WO2007050447. Drying by passing the gas through a dehydration column requires maintenance of the desiccant granules. This is because, after a certain number of passes of the gas to be dried, the desiccant granules become saturated with water and therefore inoperative as regards their dehydrating action. The desiccant granules are therefore either renewed periodically, requiring a regular maintenance operation, or regenerated, in other words dried automatically by purging some of the gas produced by the electrolyser and passing through the dehydration column, causing a loss of volume of about 10% of the gas produced by the electrolyser.

The third step consists in using a compressor to compress the dried gas flowing out of the dehydration means, and storing the compressed dried gas in a pressurized storage tank. Typically, the storage pressure of gaseous hydrogen after dehydration is between 200 and 350 bar, while the storage pressure of gaseous oxygen after dehydration is about 130 bar. An alternative solution for hydrogen storage is storage in the form of metal hydrides at low pressure, in other words at a pressure of between 5 and 15 bar. This storage pressure is substantially equal to the pressure of the gaseous hydrogen flowing out of the dehydration means, making it unnecessary to use a compressor. Metal hydrides, which may be nickel and lanthanum compounds for example, in the form of a fine powder, have the property of absorbing gaseous hydrogen when subject to a certain degree of pressure, with a small evolution of heat. In order to release the hydrogen subsequently, heat must be supplied, by using the heat losses of the fuel cell for example. When released, the hydrogen is again in the form of pure gaseous hydrogen.

The fourth step is that of taking the compressed dried gas out of storage and expanding it by means of a pressure reducer, connected to a safety valve if necessary. In the specific case of taking hydrogen out of storage where the hydrogen is stored in the form of metal hydrides, this step consists in releasing the hydrogen absorbed by the metal hydrides in gaseous form, as described above.

The fifth step consists in humidifying the expanded dried gas in order to supply the fuel cell with moist hydrogen fuel gas and oxidant gas in the form of moist oxygen. This is because a moist gas is essential for the operation of the fuel cell, in particular in order to avoid reducing its service life. There are many methods of humidification, which may be complicated, laborious and costly. Methods which may be mentioned include, notably but not exclusively, those of recycling in the hydrogen circuit, as described in US2003031906, the use of a heat exchanger with Nafion microtubes, the use of an enthalpy wheel, and water mist injection.

The sixth and final step is that of supplying the cell with the moist gaseous oxygen and hydrogen obtained from their respective humidification means.

In the case of a hydrogen-air fuel cell, only the gaseous hydrogen undergoes the six process steps described above. With regard to the first step in which gaseous hydrogen is produced by electrolysis of water, the gaseous oxygen which is produced simultaneously but is not to be supplied to the fuel cell can be discharged to the atmosphere, for example. As regards the oxidant gas, namely air, which is generally obtained from an air compressor, this may be humidified by moist air flowing out of the fuel cell, using a humidity exchanger, before the oxidant gas enters the fuel cell.

The invention is intended to overcome the drawbacks of the dehydration means described above, particularly in respect of the periodic maintenance and/or non-optimal regeneration of the dehydration means, and also in respect of the complexity and cost of the humidifying means.

The object of the invention is to propose a device for generating electricity using a fuel cell which provides automatic and efficient maintenance of the dehydration means and which uses simplified humidifying means.

This object is achieved with a device for generating electricity using a fuel cell, comprising:
a means of producing fuel gas and a means of producing oxidant gas, the respective fuel and oxidant gases being intended to supply a fuel cell in which they react chemically with one another to generate electrical energy;
at least one conditioning unit for one of the fuel and oxidant gases, comprising at least one dehydration means intended to extract at least some of the water contained in the gas passing through the unit before the gas is stored under pressure; at least two valves, one upstream and one downstream of the dehydration means; at least one means for storing the gas under pressure, and at least one means for humidifying the gas after it has been taken out of storage and decompressed;
the valves, in a first state, enabling the electricity generation device to be configured in a gas production and storage operating mode, by connecting together in series the gas production means, the dehydration means, and the means for storing the gas under pressure;
the valves, in a second state, enabling the electricity generation device to be configured in a fuel cell operating mode, by allowing the passage of one of the fuel and oxidant gases through the dehydration means for supplying the fuel cell; and the dehydration means being configured in such a way that, in fuel cell operating mode, it operates at a temperature of at least 60° C. and at least partially humidifies the gas passing through it in fuel cell operating mode, by restoring at least some of the water extracted from the gas that passed through it in the gas production and storage mode.

A device for generating electricity using a fuel cell comprises, in the first place, a means of producing fuel gas and a means of producing oxidant gas. These means of production are usually combined in a single gas production means, in the case of a hydrogen-oxygen cell. This common gas production means is conventionally an electrolyser, producing the gaseous hydrogen and oxygen by the electrolysis of water. The water to be subjected to electrolysis is generally stored in a water tank which can be supplied, at least partially, with recycled water obtained from a condenser that may be positioned downstream of the electrolyser, and/or obtained from the fuel cell. In a hydrogen-air fuel cell, the gas production means are separate: the gaseous hydrogen is usually obtained from an electrolyser, whereas the air is generally supplied by an air compressor.

A device for generating electricity using a hydrogen-oxygen fuel cell also comprises a conditioning unit for each of the hydrogen and oxygen gases. This conditioning unit comprises at least one means for dehydrating the gas before the gas is stored under pressure, at least one means for storing the gas under pressure, and at least one means for humidifying the gas after it has been taken out of storage. In the case of a hydrogen-air fuel cell, only the gaseous hydrogen undergoes the six process steps described above.

As described above, a dehydration means is a means for drying the gas, in other words for at least partially extracting the water contained in the gas, before the gas is compressed by a compressor, if required, and then stored in compressed form in a pressurized storage means such as a storage tank. This is because the compressor and storage tank generally include metal components, and are therefore subject to corrosion by any water present in the gas in contact with them, making it necessary to dry the gas to achieve a long service life of the metal components of the compressor and the storage tank. As an alternative in the case of hydrogen, storage may be provided in the form of hydrides at low pressure, in other words between 5 and 15 bar, without the use of a compressor. Where hydrides are used, it is still necessary to dry the gas beforehand, to achieve a long service life of the storage means.

A gas produced by electrolysis of water and saturated with water vapour may be partially dried, if necessary, by passing it through a condenser in order to remove some of the water from the gas before it is passed through the dehydration means. This condenser may use ambient air as its cold source, or, in a more advantageous arrangement for marine applications, may use sea water, through the intermediary of a heat exchanger.

The pressurized dry gas storage means is generally a storage tank, designed to withstand the gas pressure.

Subsequently, for the purpose of supplying the fuel cell, the dry gas, for example gaseous hydrogen or gaseous oxygen, is taken out of its storage tank, decompressed by means of a pressure reducer, and then passed through a humidifying means before being supplied to the fuel cell.

According to the invention, a valve system, comprising at least two valves, positioned respectively upstream and downstream of the dehydration means, enables the electricity generation device to be configured in two operating modes, namely a gas production and storage mode and a fuel cell operating mode. These valves are, for example, three-way valves.

In the gas production and storage operating mode, the valves, configured in a first state, connect together in series the gas production means, the means for dehydrating the gas before its pressurized storage, and the means for storing the gas under pressure. By means of this connection, each of the gases which is produced by electrolysis and subsequently dried and compressed can be stored in a storage tank. In the case of gaseous hydrogen, this can alternatively be stored in a tank in the form of metal hydrides, without preliminary compression.

In the fuel cell operating mode, the valves, configured in a second state, allow the passage of one of the fuel and oxidant gases through the dehydration means for supplying the fuel cell.

According to the invention, the dehydration means is also configured in such a way that, in the fuel cell operating mode, it operates at a temperature of at least 60° C. and at least partially humidifies the gas passing through it in fuel cell operating mode, by restoring at least some of the water extracted from the gas that passed through it in the gas production and storage mode. In other words, the dehydration means is used as a humidifying means. Thus, the dehydration means has the advantage of providing the two functions of dehydration and humidification, thereby simplifying the device for generating electricity using a fuel cell. Furthermore, the water which is stored by the dehydration means during the passage of the moist gas in gas production and storage mode is at least partially restored to the gas passing through the dehydration means in fuel cell operating mode. The removal of at least some of the water stored by the dehydration means therefore permits automatic maintenance, in other words maintenance without human intervention, for maintaining or regenerating its dehydration capacity. This has the beneficial result of increasing the overall energy efficiency of the device for generating electricity using a fuel cell, since the dehydration means is regenerated by using the free energy which is lost by the fuel cell.

The operation of the dehydration means in humidification mode at a temperature of at least 60° C. makes it possible to desorb the same amount of water as that which is absorbed in drying mode, at a temperature between 5° C. and 25° C. Thus, in order to desorb the same amount of water as that which is absorbed during the storage phase, the temperature of the gas to be humidified must be greater than that of the gas to be dried.

A preferred embodiment of the invention is an electricity generation device in which the dehydration means, which at least partially humidifies the gas passing through it, driven by a pump, in fuel cell operating mode, is configured in such a way that its operating temperature is between 60° C. and 100° C., or preferably between 60° C. and 80° C. This operating temperature is such that the water recovered by the dehydration means during the dehydration step can be converted to water vapour. The preferred temperature range [60° C., 80° C.] corresponds to the normal operating temperatures of a fuel cell. The temperature range [80° C., 100° C.] corresponds to the operating temperatures which tend to be chosen for membranes of fuel cells that are still under development. These higher temperatures are advantageous in that they make it possible, for example, to reduce the amount of platinum required for the operation of the fuel cell, or to cool the fuel cell more easily.

A variant of the preceding preferred embodiment is an electricity generation device comprising a fuel cell cooling circuit, driven by a pump, in which the dehydration means, which at least partially humidifies the gas passing through it in fuel cell operating mode, is configured in such a way that its operating temperature is partially reached as a result of an exchange of heat with the fuel cell cooling circuit. This variant embodiment makes it possible to use an existing heat source, namely the fuel cell cooling circuit, thus providing an economic advantage. It also makes it possible to obtain an operating temperature between 60° C. and 100° C., or preferably between 60° C. and 80° C., which is required in order to vaporize the water stored in the dehydration means.

It is also advantageous for the electricity generation device to be configured in such a way that the temperature of the gas entering the dehydration means, which at least partially humidifies the gas passing through it in fuel cell operating mode, is between 60° C. and 100° C., or preferably between 60° C. and 80° C. In other words, the dry expanded gas entering the dehydration means is pre-heated to a temperature enabling the stored water to be vaporized. The heating of the gas may be combined with the heating of the dehydration means described above.

If the device for generating electricity using a fuel cell comprises a fuel cell cooling circuit, the electricity generation device is advantageously configured in such a way that the temperature of the gas entering the dehydration means, which at least partially humidifies the gas passing through it in fuel cell operating mode, is at least partially reached as a result of an exchange of heat with the fuel cell cooling circuit. This embodiment makes it possible to use an existing heat source, namely the fuel cell cooling circuit, to obtain the temperature between 60° C. and 100° C., or preferably between 60° C. and 80° C., which is required in order to vaporize the water stored in the dehydration means.

In one embodiment of the invention, the device for generating electricity using a fuel cell comprises a conditioning unit for each of the fuel and oxidant gases respectively. Thus by using two separate conditioning units it is possible to avoid any contact and therefore any chemical reaction between the fuel and oxidant gases respectively, before they are supplied to the fuel cell.

This is the case, in particular, with a device for generating electricity using a hydrogen-oxygen fuel cell in which the fuel gas (gaseous hydrogen) and the oxidant gas (gaseous oxygen) are conditioned by their respective conditioning units.

In the case of a device for generating electricity using a hydrogen-oxygen fuel cell, the means for producing gaseous hydrogen and gaseous oxygen are combined in a single production means operating by electrolysis of the water obtained from a water storage tank connected to the fuel cell. This production means operating by water electrolysis is a commonly used and economical means for simultaneously producing gaseous hydrogen and gaseous oxygen.

In another embodiment of the invention, the device for generating electricity using a fuel cell comprises a conditioning unit for the oxidant gas only.

This is the case, notably, in a hydrogen-air fuel cell, in which only the gaseous hydrogen, produced by the electrolysis of water, has a conditioning unit in the sense of the invention. The air, which is generally obtained from a compressor, in other words from a production means separate from that used for the gaseous hydrogen, does not require a conditioning unit of this type.

In a preferred embodiment of the invention, the dehydration means, which, in gas production and storage mode, is intended to extract at least some of the water contained in the gas passing through it before the gas is stored under pressure, is configured in such a way that the same gas passes through it in fuel cell operating mode. In other words, the dehydration means, which, in gas production and storage mode, dries the gas passing through it before the gas is stored under pressure, also humidifies the same gas after it has been taken out of storage and before it is supplied to the fuel cell, in fuel cell operating mode. Thus the dehydration means provides the two functions of dehydration and humidification for the same gas. Advantageously, the dehydration means therefore has gas of the same chemical composition passing through it, thus avoiding any risk of chemical reaction within the dehydration means. In the case of a hydrogen-oxygen fuel cell, the gaseous hydrogen and gaseous oxygen circuits are thus entirely separate from each other.

In another advantageous embodiment of the invention, the dehydration means, which, in gas production and storage mode, is intended to extract at least some of the water contained in a first gas passing through it before the storage of the gas under pressure, is configured in such a way that a second gas passes through it in fuel cell operating mode. In other words, the dehydration means, which, in gas production and storage mode, dries a first gas passing through it before the gas is stored under pressure, humidifies a second gas after it has been taken out of storage and before it is supplied to the fuel cell, in fuel cell operating mode. Thus the dehydration means provides the two functions of dehydration and humidification, but for different gases. The term “first gas” signifies the gas passing through the dehydration means in gas production and storage mode, and the term “second gas” signifies the gas passing through the dehydration means in fuel cell operating mode. By way of example, in the case of a hydrogen-air fuel cell, the dehydration means for the gaseous hydrogen may humidify the compressed air, which in return dries the dehydration means, possibly making it unnecessary to heat the dehydration means. As for the gaseous hydrogen, which is not humidified by its own dehydration means, this may then be humidified by recycling the surplus moist gaseous hydrogen flowing out of the fuel cell.

Another preferred embodiment of the invention is a device for generating electricity using a fuel cell in which the dehydration means is formed by at least one dehydration column containing desiccant granules, which is a known and mature technology.

In a variant of the preceding preferred embodiment, the desiccant granules of a dehydration column are of the silica gel type, a material commonly used in this type of application.

It is also advantageous for the hydrogen storage means to take the form of metal hydrides, as this storage means makes it unnecessary to use a compressor downstream of the dehydration means.

The invention also proposes the use of a device for generating electricity using a fuel cell according to the invention for a motor vehicle.

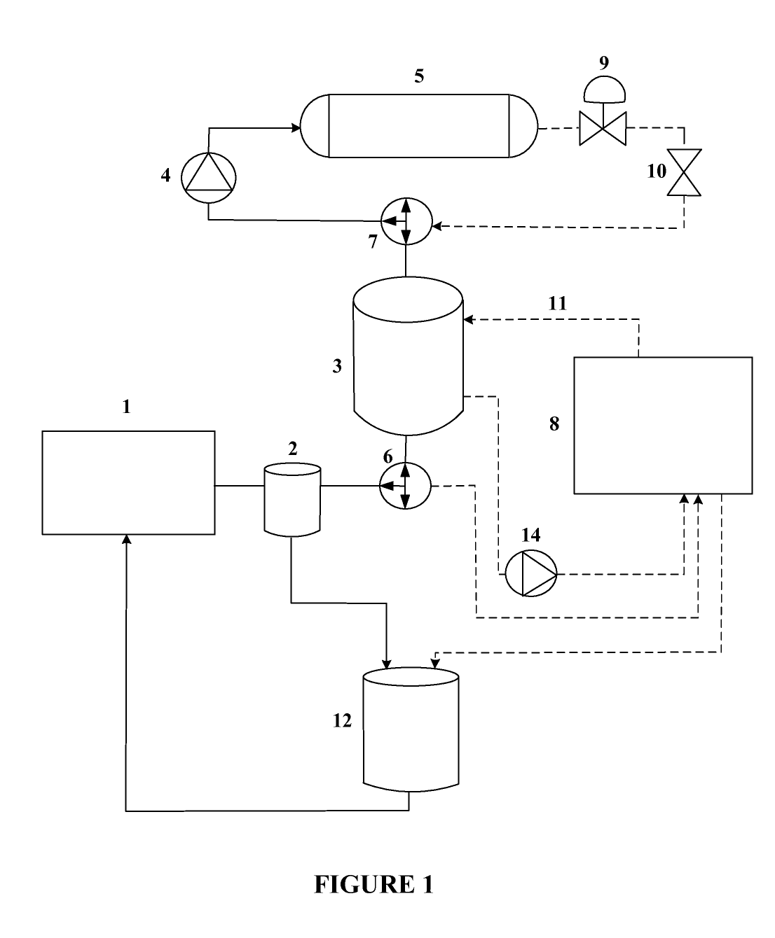

The characteristics and other advantages of the invention will be more apparent from the appended FIGS. 1 to 3, in which:

FIG. 1 shows the circuit of one of the two gases supplied to the fuel cell, in gas production and storage mode, in the case in which the device for generating electricity using a fuel cell comprises a conditioning unit for each of the fuel and oxidant gases respectively.

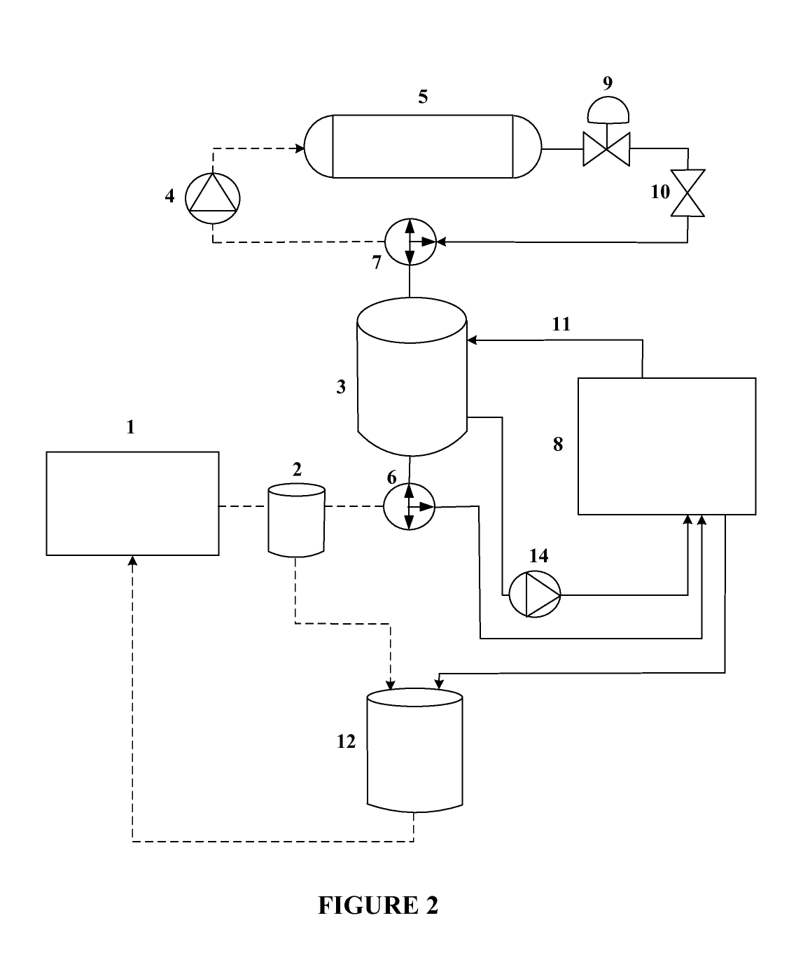

FIG. 2 shows the circuit of one of the two gases supplied to the fuel cell, in fuel cell operating mode, in the case in which the device for generating electricity using a fuel cell comprises a conditioning unit for each of the fuel and oxidant gases respectively.

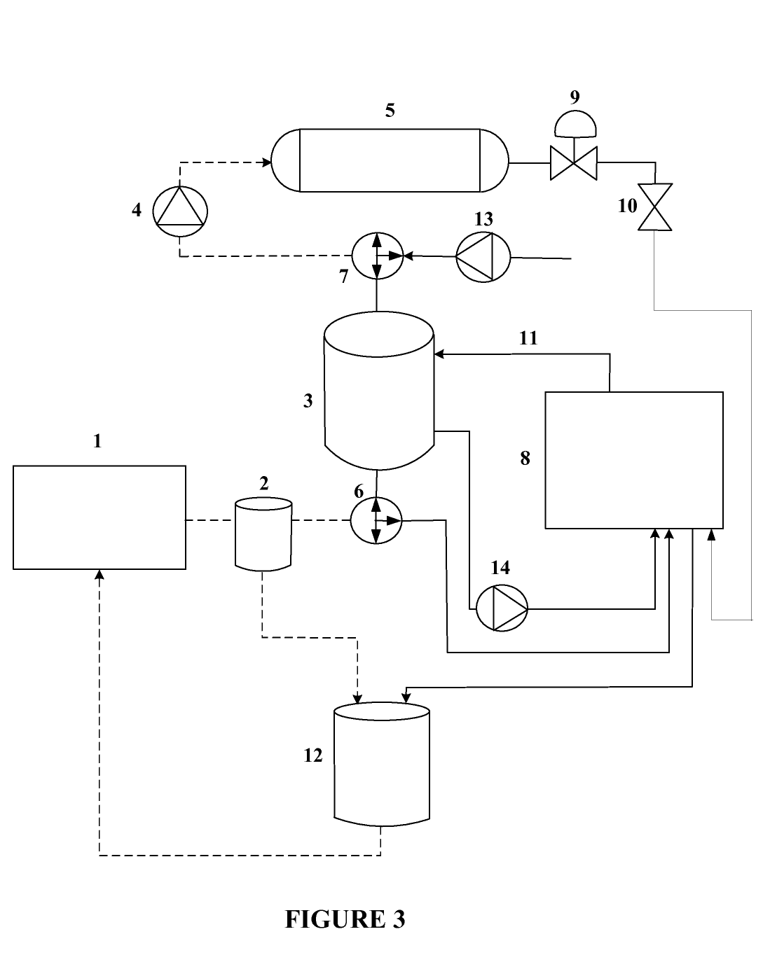

FIG. 3 shows the circuit of the two gases supplied to the fuel cell, in fuel cell operating mode, where the device for generating electricity using a fuel cell comprises a conditioning unit for the oxidant gas only.

FIGS. 1 and 2 show schematically the circuit of only one of the two gases, these two gases being the fuel and oxidant gases respectively, this circuit being similar for each of the gases.

FIG. 1 shows the circuit of one of the two gases supplied to the fuel cell, in gas production and storage mode, between the gas production means (1) and the pressurized storage means (5). This circuit is described below with reference to the gaseous hydrogen supplied to a hydrogen-oxygen fuel cell. Additionally, the part of the circuit in operation for a given operating mode is shown in solid lines, while the part of the circuit not in operation is shown in broken lines.

The gaseous hydrogen and oxygen are produced using the gas production means (1), by electrolysis of the water stored in the water tank (12). The water tank (12) is supplied, at least partially, with recycled water obtained from a condenser (2) positioned downstream of the electrolyser (1), and with recycled water obtained from the fuel cell (8). The gaseous hydrogen, obtained from the gas production means (1) and saturated with water vapour, is partially dried in a condenser (2). The actual dehydration is then carried out at ambient temperature, in other words at between 20° C. and 25° C., in the dehydration means (3). The gas which has been dried in this way passes out of the dehydration means (3), is compressed in a compressor (4), typically at between 200 bar and 350 bar for gaseous hydrogen, and is then stored in a pressurized storage means or tank (5). Alternatively, in the case of hydrogen, the use of the compressor (4) may be unnecessary if the gas is stored in a tank (5) in the form of hydrides, at a pressure in the range from 5 to 15 bar. Three-way valves (6) and (7), positioned upstream and downstream of the dehydration means (3) respectively, are configured in gas production and storage mode; in other words, they connect together in series the gas production means (1), the means for dehydrating the gas before its pressurized storage (3), and the means for storing the gas under pressure (5).

FIG. 2 shows the circuit of one of the two gases supplied to the fuel cell, in fuel cell operating mode, this circuit running from the pressurized storage means (5) to the fuel cell (8). As in FIG. 1, the circuit is described below with reference to the gaseous hydrogen supplied to a hydrogen-oxygen fuel cell.

In fuel cell operating mode, the dry gaseous hydrogen is taken out of its pressurized storage means (5) and is decompressed by means of a pressure reducer (9), this pressure reducer being associated with a safety valve (10) positioned downstream of the pressure reducer (9). The decompressed dry gaseous hydrogen is then humidified during its passage through the dehydration means (3) at an operating temperature of between 60° C. and 100° C., or preferably between 60° C. and 80° C. This operating temperature is obtained by heat exchange between the dehydration means (3) and the cooling circuit (11) of the fuel cell (8). The liquid of this cooling circuit is driven by the pump (14).

FIG. 3 shows the circuits of the two gases supplied to the fuel cell, in fuel cell operating mode. This is the case, for example, when a hydrogen-air fuel cell is used. In this embodiment, the dry gaseous hydrogen is taken out of its pressurized storage means (5) and is decompressed by means of a pressure reducer (9), this pressure reducer being associated with a safety valve (10) positioned downstream of the pressure reducer (9). The decompressed dry gaseous hydrogen is then humidified by the recycling of the surplus moist gaseous hydrogen flowing out of the fuel cell (8). The air, flowing out of a compressor (13), enters the gaseous hydrogen dehydration means (3) through the valve (7) and is humidified therein, before being supplied to the fuel cell (8).

This variant embodiment, comprising a single conditioning unit for gaseous hydrogen only, in which the gaseous hydrogen is humidified by its own dehydration means and the air is humidified by the moist air flowing out of the fuel cell, is not shown.

The invention is not to be interpreted as being limited to the examples described above and illustrated in FIGS. 1 to 3, but can be extended to other embodiments, including but not limited to:
a device for generating electricity using a fuel cell, comprising a dehydration means in the form of a column comprising desiccant granules of a type other than silica gel,
a device for generating electricity using a fuel cell, comprising a dehydration means comprising a desiccant material in solid phase which is different from desiccant granules,
a device for generating electricity using a fuel cell, comprising a plurality of means for dehydration and storage, together with a plurality of fuel cells.

Finally, this type of device for generating electricity using a fuel cell is not limited to the supply of electrical energy for a motor vehicle, but may be used for any device requiring an electrical energy supply.

1. Device for generating electricity using a fuel cell, comprising:
a means of producing fuel gas and a means of producing oxidant gas, the respective fuel and oxidant gases being intended to supply a fuel cell in which they react chemically with one another to generate electrical energy;
at least one conditioning unit for one of the fuel and oxidant gases, comprising at least one dehydration means intended to extract at least some of the water contained in the gas passing through the unit before the gas is stored under pressure; at least two valves, one upstream and one downstream of the dehydration means; at least one means for storing the gas under pressure, and at least one means for humidifying the gas after it has been removed from storage and decompressed;
the valves, in a first state, enabling the electricity generation device to be configured in gas production and storage operating mode, by connecting together in series the gas production means, the dehydration means, and the means for storing the gas under pressure (5);
wherein the valves, in a second state, enable the electricity generation device to be configured in fuel cell operating mode, allowing the passage of one of the fuel and oxidant gases through the dehydration means for supply to the fuel cell, and in that the dehydration means is configured in such a way that, in fuel cell operating mode, it operates at a temperature of at least 60° C. and at least partially humidifies the gas passing through it, by restoring at least some of the water extracted from the gas that passed through it in gas production and storage mode.

2. Device for generating electricity using a fuel cell according to claim 1, wherein the dehydration means, which at least partially humidifies the gas passing through it in fuel cell operating mode, is configured in such a way that its operating temperature is between 60° C. and 100° C., or preferably between 60° C. and 80° C.

3. Device for generating electricity using a fuel cell according to claim 1, comprising a cooling circuit of the fuel cell, driven by a pump, wherein the dehydration means, which at least partially humidifies the gas passing through it in fuel cell operating mode, is configured in such a way that its operating temperature is at least partially reached as a result of an exchange of heat with the cooling circuit of the fuel cell.

4. Device for generating electricity using a fuel cell according to claim 1, wherein the electricity generation device is configured in such a way that the temperature of the gas entering the dehydration means, which at least partially humidifies the gas passing through it in fuel cell operating mode, is between 60° C. and 100° C., or preferably between 60° C. and 80° C.

5. Device for generating electricity using a fuel cell according to claim 1, comprising a cooling circuit of the fuel cell, driven by a pump, wherein the electricity generation device is configured in such a way that the temperature of the gas entering the dehydration means, which at least partially humidifies the gas passing through it in fuel cell operating mode, is at least partially reached as a result of an exchange of heat with the cooling circuit of the fuel cell.

6. Device for generating electricity using a fuel cell according to claim 1, wherein the device for generating electricity using a fuel cell comprises a conditioning unit for each of the fuel and oxidant gases respectively.

7. Device for generating electricity using a fuel cell according to claim 6, wherein the fuel and oxidant gases are, respectively, gaseous hydrogen and gaseous oxygen.

8. Device for generating electricity using a hydrogen-oxygen fuel cell according to claim 7, wherein the means for producing gaseous hydrogen and gaseous oxygen are combined in a production means based on the electrolysis of water obtained from a water storage tank connected to the fuel cell.

9. Device for generating electricity using a fuel cell according to claim 1, wherein the device for generating electricity using a fuel cell comprises a conditioning unit for the fuel gas only.

10. Device for generating electricity using a fuel cell according to claim 9, wherein the fuel and oxidant gases are, respectively, gaseous hydrogen and air.

11. Device for generating electricity using a fuel cell according to claim 10, wherein the means for producing gaseous hydrogen is a production means operating by electrolysis of the water obtained from a water storage tank connected to the fuel cell, and in that the air production means is an air compressor.

12. Device for generating electricity using a fuel cell according to claim 1, wherein the dehydration means, which is intended to extract at least some of the water contained in the gas passing through it before the storage of the gas under pressure in gas production and storage mode, is configured in such a way that the same gas passes through it in fuel cell operating mode.

13. Device for generating electricity using a fuel cell according to claim 1, wherein the dehydration means, which is intended to extract at least some of the water contained in a first gas passing through it before the storage of the gas under pressure in gas production and storage mode, is configured in such a way that a second gas passes through it in fuel cell operating mode.

14. Device for generating electricity using a fuel cell according to claim 1, wherein the dehydration means is formed by at least one dehydration column containing desiccant granules.

15. Device for generating electricity using a fuel cell according to claim 14, wherein the desiccant granules of a dehydration column are of the silica gel type.

16. Device for generating electricity using a fuel cell according to claim 1, wherein the hydrogen storage means is provided in the form of metal hydrides.

17. A method for generating electricity for a motor vehicle comprising an operating device according to claim 1.
